(19) United States
(12) Patent Application Publication
(10) Pub. No.: US 2019/0063150 A1
(43) Pub. Date: Feb. 28, 2019

(54) CORD SEPARATOR FOR BLIND CORD WINDING MECHANISM

(71) Applicant: SHEEN WORLD TECHNOLOGY CORPORATION, Taichung City (TW)

(72) Inventor: Po-Yu CHEN, TAICHUNG CITY (TW)

(21) Appl. No.: 15/888,686

(22) Filed: Feb. 5, 2018

(30) Foreign Application Priority Data
Aug. 28, 2017 (TW) 106129212

(51) Int. Cl. E06B 9/382; E06B 9/68

(52) U.S. Cl. CPC E06B 9/382; E06B 9/68

(57) ABSTRACT

A cord separator used in a blind cord winding mechanism is disclosed to include a support portion, two wing portions respectively and outwardly extended from two opposite lateral sides of the support portion and respectively defining therein a cord insertion hole for the passing of one respective transmission cord, and two extension portions respectively perpendicularly extended from the wing portions along the axial direction of the cord insertion holes in parallel manner and respectively terminating in a positioning end portion for hooking on one respective side post of the blind cord winding mechanism so that the cord separator is capable of separating two transmission cords of the blind cord winding mechanism and preventing the two transmission cords from interfering with each other or being tangled during transmission.

### BACKGROUND OF THE INVENTION

### 1. Field of the Invention

The present invention relates to window blind technology, and more particularly to a cord separator for use in a blind cord winding mechanism of a window blind.

### 2. Description of the Related Art

In regular window blinds, the extending out or receiving the slats is performed through the transmission of pairs of transmission cords. For example, when receiving the slats, the transmission cords are rolled up to lift the bottom rail as the winding gears are driven to rotate, and thus the slats are lifted by the bottom rail and received in a stack.

In prior art designs, the transmission cords can interfere with each other or can be tangled, resulting unsmoothness of the lifting of the slats or even causing the slats to get stuck.

### SUMMARY OF THE INVENTION

The present invention has been accomplished under the circumstances in view. It is the main object of the present to provide a cord separator for blind cord winding mechanism, which prevents the transmission cords from interfering with each other or being tangled during transmission.

To achieve this and other objects of the present invention, a cord separator is used in a blind cord winding mechanism, comprising a support portion, two wing portions and two extension portions. The two wing portions are respectively and outwardly extended from two opposite lateral sides of the support portion, each wing portion defining therein a cord insertion hole. The extension portions are respectively perpendicularly extended from the wing portions along the axial direction of the cord insertion holes in parallel manner, and respectively terminating in a positioning end portion.

Preferably, the support portion is an elongated member; the two wing portions are respectively extended from the support portion at different elevations and disposed in rotational symmetry along with a long axis of said elongated member; the two cord insertion holes are disposed at different elevations.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 illustrates two cord separator mounted at two opposite ends of a blind cord winding mechanism in accordance with the present invention.

FIG. 2 is an exploded view of a part of FIG. 1, illustrating the structure of the cord separator.

FIG. 3 is a sectional view of a part of FIG. 1, illustrating the positioning of the cord separator in the blind cord winding mechanism.

### DETAILED DESCRIPTION OF THE INVENTION

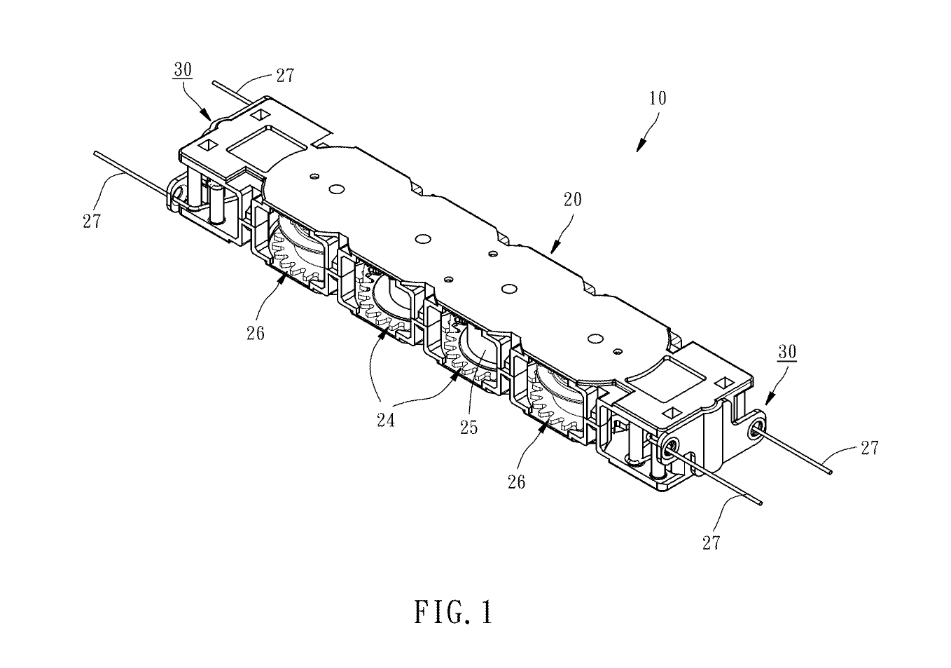

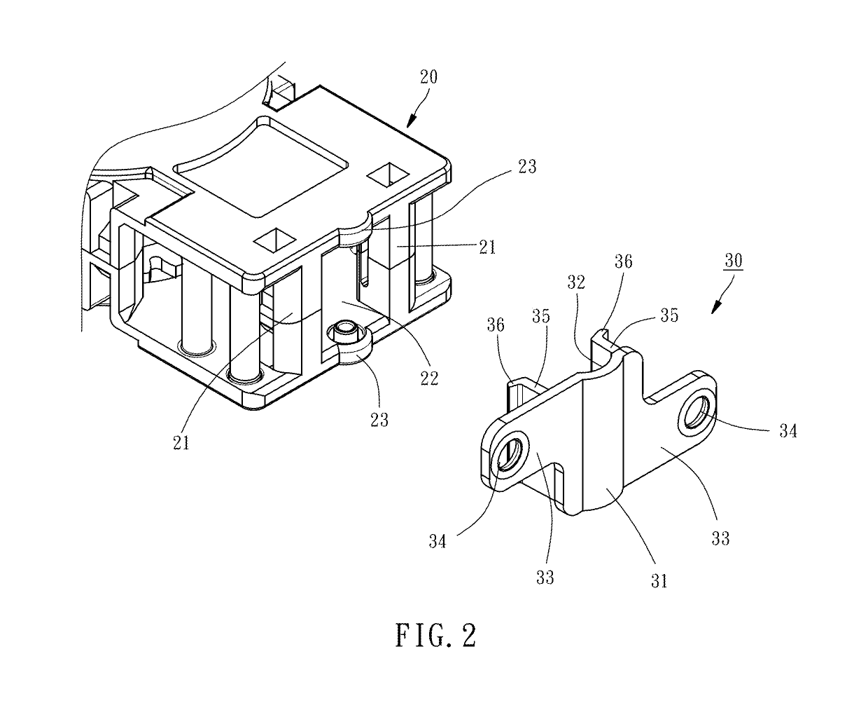

Referring to FIG. 1 and FIG. 2, a regular blind cord winding mechanism 10 is used in a window blind for controlling receiving and extending out of the slats, which structurally comprises a casing 20, two driving gears 24, a coil spring 25, two transmission cord winding gears 26, and four transmission cords 27 that are arranged in pairs. The casing 20 comprises two opposite side posts 21 bilaterally disposed in parallel at each of two opposite ends thereof, an end opening 22 defined between each pair of side posts 21, and two protruding portions 23 located at opposite top and bottom sides of each end opening 22. The two driving gears 24 are rotatably mounted in the casing 20 and meshed with each other. The coil spring 25 is connected between the two driving gears 24, and can be extended out from the coiled status upon rotation of the driving gears 24. The two transmission cord winding gears 26 are rotatably mounted in the casing 20 and respectively meshed with one respective driving gear 24 so that the two transmission cord winding gears 26 can be driven to rotate by the respective driving gears 24. The two pairs of transmission cords 27 are respectively mounted around one respective transmission cord winding gear 26 at different elevations so that each pair of transmission cords 27 can be rolled up by the respective transmission cord winding gear 26 or let off from the respective transmission cord winding gear 26.

Referring to FIG. 2, a cord separator 30 comprises a support portion 31, two wing portions 33, and two extension portions 35. The support portion 31 is an elongated member having an arched cross section. The two wing portions 33 are respectively and outwardly extended from two opposite lateral sides of the support portion 31, each wing portion defining therein a cord insertion hole 34. Further, the two wing portions 33 are respectively extended from the support portion 31 at different elevations and disposed in rotational symmetry along with a long axis of the support portion 31 so that the cord insertion holes 34 of the wing portions 33 are disposed at different elevations for the passing of one respective pair of transmission cords 27. The two extension portions 35 are respectively perpendicularly extended from the wing portions 33 along the axial direction of the cord insertion holes 34 in parallel manner, and respectively terminating in a positioning end portion 36.

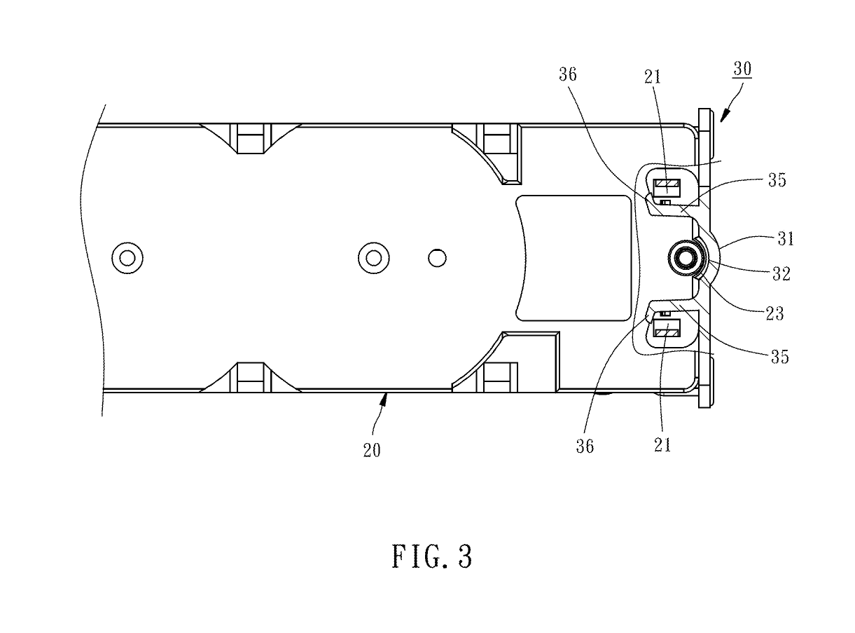

In application, two cord separators 30 are respectively mounted at the two opposite ends of the casing 20 of the blind cord winding mechanism 10 to face toward the respective transmission cord winding gears 26. In installation, as illustrated in FIG. 3, insert the two extension portions 35 into the end opening 22 at one end of the casing 20 to force an inner concave surface 32 of the support portion 31 into abutment against the two protruding portions 23 at the respective end of the casing 20, enabling the positioning end portions 36 of the two extension portions 35 to be respectively hooked on the respective side posts 21 of the casing 20 to complete the installation. After installation, as illustrated in FIG. 1, the cord separator 30 separates the two transmission cords 27, preventing the two transmission cords 27 from interfering with each other or being tangled during transmission and enhancing the transmission smoothness and stability.

What is claimed is:

1. A cord separator used in a blind cord winding mechanism, comprising a support portion, two wing portions and two extension portions, said two wing portions being respectively and outwardly extended from two opposite lateral sides of said support portion, each said wing portion defining therein a cord insertion hole, said extension portions being respectively perpendicularly extended from said wing portions along the axial direction of said cord insertion holes in parallel manner and respectively terminating in a positioning end portion.

2. The cord separator as claimed in claim 1, wherein said support portion is an elongated member; said two wing portions are respectively extended from said support portion at different elevations and disposed in rotational symmetry along with a long axis of said support portion.

3. The cord separator as claimed in claim 1, wherein said support portion has an arched cross section.

4. The cord separator as claimed in claim 1, wherein said two cord insertion holes are disposed at different elevations.
